(19) United States
(12) Patent Application Publication
(10) Pub. No.: US 2022/0099593 A1
(43) Pub. Date: Mar. 31, 2022

(54) METHODS AND SYSTEMS FOR REDUCING DEFECTS

(71) Applicant: Utica Leaseco, LLC, Rochester Hills, MI (US)

(72) Inventors: Sean SWEETNAM, Menlo Park, CA (US); Octavi Santiago Escala SEMONIN, San Francisco, CA (US); Vineet KUMAR, Mountain View, CA (US); Gang HE, Fremont, CA (US); Melissa ARCHER, San Jose, CA (US)

(21) Appl. No.: 17/484,924

(22) Filed: Sep. 24, 2021

Related U.S. Application Data
(60) Provisional application No. 63/083,417, filed on Sep. 25, 2020.

(51) Int. Cl. G01N 21/95; G06T 7/00

(52) U.S. Cl. CPC G01N 21/9505; G06T 2207/30148; G06T 7/001

(57) ABSTRACT

Aspects of the present disclosure include methods, apparatuses, and computer readable media for transmitting a light such that is incident on a semiconductor device, detecting a first reflected light from a first layer of the semiconductor device and a second reflected light from a second layer of the semiconductor device, identifying a defect in the first layer based on the first reflected light and the second reflected light, wherein the defect provides a shunt path between a top electrode to be deposited on the first layer and the second layer, and performing a defect reduction procedure on the semiconductor device to compensate for the defect in response to identifying the defect.

### CROSS REFERENCE TO RELATED APPLICATIONS

The current application claims priority to, and the benefit of U.S. Provisional Application No. 63/083,417 filed on Sep. 25, 2020, entitled “METHODS AND SYSTEMS FOR REDUCING DEFECTS,” the contents of which are hereby incorporated by reference in their entireties.

### BACKGROUND

Many semiconductor films are grown using epitaxy, where a layer of first crystalline material is grown over a substrate. The substrate may include a second crystalline material that may be the same or different from the first crystalline material. For example, gallium arsenide crystalline material may be grown over a sapphire substrate. Common equipment used for epitaxial growth may include metal-organic chemical vapor deposition (MOCVD), molecular beam epitaxy system, atomic layer deposition, or other suitable equipment.

However, epitaxy growth may lead to “defects,” which are voids in the epitaxial film (e.g., crystalline material). Defects may occur due to unintentional etching along dislocations of the epitaxial film, thermal strain, preferential etching, or other effects. Examples of defects may include fissures, cracks, holes, openings, gaps, slits, grooves, breaks, fractures, splits, or faults. These defects may result in “shunts” by providing conductive paths (e.g., for metal) through the epitaxial film, and may therefore electrically connect two points that would otherwise need to be electrically isolated. While it is possible to reduce the probability of shunts by indiscriminately reducing the amount of metal deposited over the epitaxial film (i.e., reduces the surface area of metal to reduce the probability of shunts), this process does not eliminate the shunts and may reduce the performance of the semiconductor device. Therefore, improvements in defect reduction is desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In certain implementations, aspects of the present disclosure include methods, apparatuses, and computer readable media for transmitting a light such that is incident on a semiconductor device, detecting a first reflected light from a first layer of the semiconductor device and a second reflected light from a second layer of the semiconductor device, identifying a defect in the first layer based on the first reflected light and the second reflected light, wherein the defect is a defect in the semiconductor device that provides a shunt path between a top electrode to be deposited on the first layer and the second layer, and performing a defect reduction procedure on the semiconductor device to compensate for the defect in response to identifying the defect.

A system may include a deposition system, one or more light sources configured to transmit a light such that is incident on a semiconductor device, a detector configured to detect a first reflected light from a first layer of the semiconductor device and a second reflected light from a second layer of the semiconductor device, an optical controller configured to identify a defect in the first layer based on the first reflected light and the second reflected light, wherein the defect is a defect in the semiconductor device that provides a shunt path between a top electrode to be deposited on the first layer and the second layer, and a deposition controller configured to perform a defect reduction procedure on the semiconductor device to compensate for the defect in response to identifying the defect.

Aspects of the present disclosure include a non-transitory computer readable medium having instructions stored therein that, when executed by one or more processors of a defect reduction system, cause one or more light sources to transmit a light such that is incident on a semiconductor device, cause a detector to detect a first reflected light from a first layer of the semiconductor device and a second reflected light from a second layer of the semiconductor device, cause an optical controller to identify a defect in the first layer based on the first reflected light and the second reflected light, wherein the defect is a defect in the semiconductor device that provides a shunt path between a top electrode to be deposited on the first layer and the second layer, and cause a deposition system perform a defect reduction procedure on the semiconductor device to compensate for the defect in response to identifying the defect.

Other aspects of the present disclosure include a system that detects one or more defects in a semiconductor layer of a dual junction solar cell using the photoluminescence of the semiconductor layer and an underlying layer (e.g., another semiconductor layer). In response to detecting the one or more defects, the system may perform a defect reduction procedure including filling the one or more defects with an insulating material, selectively preventing the deposition of a top electrode over the one or more defect, or changing a size or a position of atop electrode to be deposited onto the first semiconductor layer to avoid an overlap between the top electrode and the defect.

In certain implementations, aspects of the present disclosure include methods for transmitting a light such that it is incident on a semiconductor device, detecting a scattered light from the semiconductor device, identifying a defect based on the scattered light, and performing a defect reduction procedure on the semiconductor device to compensate for the defect in response to identifying the defect.

A system may include a deposition system, one or more light sources configured to transmit a light such that it is incident on a semiconductor device, a detector configured to detect a scattered light from the semiconductor device, an optical controller configured to identify a defect based on the scattered light, and a deposition controller configured to perform a defect reduction procedure on the semiconductor device to compensate for the defect in response to identifying the defect.

Aspects of the present disclosure include a non-transitory computer readable medium having instructions stored therein that, when executed by one or more processors of a defect reduction system, cause one or more light sources to transmit a light such that it is incident on a semiconductor device, cause a detector to detect a scattered light from the semiconductor device, cause an optical controller to identify a defect based on the scattered light, and cause a deposition system perform a defect reduction procedure on the semiconductor device to compensate for the defect in response to identifying the defect.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram of a semiconductor device including one or more defects;

FIG. 2 is a schematic diagram of an example of a defect reduction system according to aspects of the present disclosure;

FIG. 3 is a schematic diagram of an example of a computer system for implementing the defect reduction system;

FIG. 4 is a diagram of a semiconductor device including a defect being filled to avoid shunting according to aspects of the present disclosure;

FIG. 5 is a diagram of a semiconductor device with a top electrode not deposited over a defect according to aspects of the present disclosure;

FIG. 6 is a diagram of a semiconductor device with a top electrode shifted and/or resized according to aspects of the present disclosure;

FIG. 7 is a diagram illustrating examples of defect reduction methods according to aspects of the present disclosure;

FIG. 8 is a process flow diagram of an example of defect reduction according to aspects of the present disclosure;

FIG. 9 is a schematic diagram of another example of a defect reduction system according to aspects of the present disclosure;

FIG. 10 is a diagram of an example of image processing according to aspects of the present disclosure;

FIG. 11 is a diagram illustrating a first example of the offset defect reduction technique according to aspects of the present disclosure;

FIG. 12 is a diagram illustrating a first example of the backfill defect reduction technique according to aspects of the present disclosure;

FIG. 13 is a diagram illustrating a first example of the mask-modification defect reduction technique according to aspects of the present disclosure;

FIG. 14 is a diagram illustrating a second example of the offset defect reduction technique according to aspects of the present disclosure;

FIG. 15 is a diagram illustrating a second example of the backfill defect reduction technique according to aspects of the present disclosure;

FIG. 16 is a diagram illustrating a second example of the mask-modification defect reduction technique according to aspects of the present disclosure; and

FIG. 17 is a process flow diagram of another example of defect reduction according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Specifically, in one implementation, high-resolution images are taken of post-epitaxial lift-off (ELO) films illuminated with a ring light in “dark field” mode. When a film is illuminated at an angle, e.g. with a ring light, then light is scattered by features that have height. Edges of etch pits are typically abrupt steps, and thus they scatter light. Etch pits are visible in these high-resolution images and can be automatically detected. One such detection algorithm is as follows: 1) Image a film at high resolution with illumination at an angle. One film may comprise hundreds of sub-images. 2) Isolate the “value” channel from an image. 3) Set a threshold based on median intensity of the image, creating a binary mask. 4) Iteratively dilate and erode the mask, “closing” edges of etch pits into filled-in etch pits. 5) Map the filled-in defects, e.g. using an algorithm to find locations of all connected components in the closed mask. 6) Combine the resulting maps of defects for each sub-image to create an etch pit map for each film.

According to an aspect of the present disclosures, the etch pits may be corrected via one or more of the following techniques: 1) Offset variation: The front metal mask may be offset to a location that minimizes the number of locations of overlap between front metal and etch pits, 2) Minor pattern variation: The front metal mask may be edited minorly, while the location of it with respect to the film remains fixed; specifically, given the etch pit map for a film, pixels of resist may be added inside the nominal front metal area, such that front metal cannot contact an etch pit, and 3) Major pattern variation: The front metal mask may be edited significantly, while the location of the mask with respect to the film remains fixed. Specifically, given the etch pit map for a film, the finger pitch, finger width, finger length, and/or busbar width may be adjusted to avoid front metal contacting etch pits.

After epitaxial growth, some wafers may have defects which may adversely affect performance and reliability of the cell, particularly when the defect encounters back metal. For example, particles may land before or during growth, causing distortions of the epitaxial layer. Note that particles are not the only example of this effect. The distorted layers are susceptible to etching and may lead to shunts when either back metal or front metal is deposited on the defect. Further, the distortion may nucleate defects in the back metal which allows etching chemistry into the layer interfaces, sometimes leading to delamination.

Delamination and shunts are both defects. Many of these defects are masked by the dielectric print step, which coats the wafer with a layer of inkjet-printed dielectric. This coating has discontinuities, however, as vias are necessary for the semiconductor to make contact to the back metal. Also, there are “streets” between the cells, where we either print no dielectric, or 100% contiguous dielectric.

In some implementations, wafers may be inspected for defects after epitaxial growth. This post-epi characterization step yields a map of defects for each wafer. In the epi particle example, the map may be of particles that appear likely to cause shunts. This map may then be used to modify the inkjet dielectric print pattern. This may include three types of changes: 1) Offset variation: the dielectric pattern of cells, streets, and vias may be offset to a location that minimizes the number of locations of overlap between back metal and defects, 2) Minor pattern variation: the dielectric mask may be edited minorly, while the location of it with respect to the wafer remains fixed; specifically, given the defect map for a wafer, pixels of dielectric may be added inside a nominal via area, such that back metal cannot contact a defect; this pixel could fill the entire via, if necessary, or 3) Major pattern variation: the dielectric mask may be edited significantly, while the location of the mask with respect to the film remains fixed. Specifically, given the defect map for a wafer, the street width and shape, or via position, size, pitch, and layout may be adjusted to avoid back metal contacting defects.

This defect map is combined with the image used to print dielectric, creating a unique mask for each wafer. Covering the defects with dielectric prevents the shunting of the semiconductor. This concept could be expanded to any defect type observable at post-epi characterization. For example, cracks and tears can “rip out” semiconductor from the wafer. Masking this defect would also contribute to improved yield.

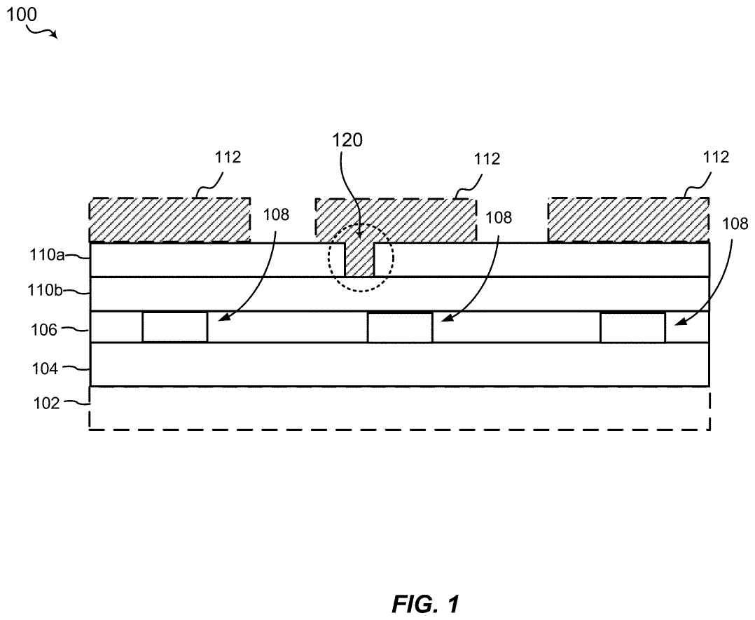

Referring to FIG. 1, in certain aspects, a semiconductor device 100 may be a solar cell (also referred to as photovoltaic (PV) devices), a light emitting device, or other optical semiconductor device, or a structure that is integral to any of these devices. In one example, the semiconductor device 100 may be a single junction solar cell. In other examples, the semiconductor device 100 may be a dual junction or a multi junction solar cell. The semiconductor device 100 may include an optional carrier 102. The carrier 102 may be a heavily doped (P-type or N-type) silicon substrate, an intrinsic silicon substrate, an oxidized silicon substrate, a glass substrate, a sapphire substrate, or other substrates. The size (edge or diameter) of the carrier 102 may be 1 inch, 2 inches, 4 inches, 6 inches, 10 inches, 12 inches, 15 inches, or other sizes. The semiconductor device 100 may include one or more bottom electrodes 104. The one or more bottom electrodes 104 may include electrically conductive materials such as metals, including silver, gold, palladium, platinum, or other elemental metal materials or alloys. The one or more bottom electrodes 104 may include a carrier transport layer, a carrier injection layer, and/or a carrier extraction layer.

In some implementations, the semiconductor device 100 may include a dielectric layer 106 having one or more vias 108. The one or more vias 108 may be created by selectively etching (dry or wet etching following a photolithography patterning) a portion of the dielectric layer 106.

In some aspects of the present disclosure, the semiconductor device 100 may include a first semiconductor layer 110a and an optional second semiconductor layer 110b. The semiconductor device 100 may include a single semiconductor layer. The semiconductor device 100 may include more than two semiconductor layers, however, in this example two layers are shown for illustrative purposes. The semiconductor layers 110a, 110b may be a light absorbing semiconductor, such as gallium arsenide, gallium arsenide phosphide, gallium phosphide, aluminum gallium arsenide, aluminum gallium nitride, aluminum gallium indium phosphide, aluminum gallium indium nitride, aluminum gallium, aluminum phosphide, aluminum nitride, zinc selenide, indium gallium nitride, indium gallium arsenide, indium gallium phosphide, silicon carbide, alloys thereof, combinations thereof, or other elemental, molecular (e.g., II-VI or III-V compounds), or organic semiconductors. In a non-limiting example, the semiconductor layer 110a may include indium gallium phosphide, and the semiconductor layer 110b may include gallium arsenide. The semiconductor layer 110b may include an optional reflective layer near the junction with the dielectric layer 106. In some examples, the one or more bottom electrodes 104 may contact the semiconductor layer 110b through the one or more vias 108.

In some implementations, the semiconductor layer 110a and the semiconductor layer 110b may be different materials. The semiconductor layer 110a may absorb light having a first wavelength or a first range of wavelengths and the semiconductor layer 110b may absorb light having a second wavelength or a second range of wavelengths. For example, the semiconductor layer 110a may be efficient at absorbing light having wavelengths between approximately 400 nanometer (nm) to 700 nm. The semiconductor layer 110b may be efficient at absorbing light having wavelengths between approximately 500 nm to 900 nm.

In certain examples, the semiconductor layer 110a may include one or more defects 120 (dashed line). The one or more defects 120 may be fissures, cracks, holes, or other types of voids in the semiconductor layer 110a. The one or more defects 120 may be created during the epitaxial lift-off process and/or the epitaxial growth of the semiconductor layer 110a. In some implementations, the one or more defects 120 may expose a portion of the semiconductor layer 110b. In other implementations, the one or more defects 120 may be a “dent” in the semiconductor layer 110a that does not expose a portion of the semiconductor layer 110b.

In certain aspects, if the semiconductor device 100 includes a single semiconductor layer (e.g., the semiconductor layer 110a), the one or more defects 120 may expose the dielectric layer 106 and/or some of the one or more vias 108.

In a non-limiting example, the semiconductor layer 110a and the semiconductor layer 110b may be the same material (i.e., the semiconductor layers 110a, 110b constitute a single layer). The one or more defects 120 may be a void, fracture, fault line, hole, pit, or cavity in the semiconductor layers 110 that does not breach through the entire semiconductor layers 110. The one or more defects 120 may expose a portion of the semiconductor layer 110b.

In an aspect, the semiconductor device 100 may include one or more top electrodes 112. The one or more top electrodes 112 may include indium tin oxide, aluminum doped zinc oxide, fluorine doped tin oxide, silver, gold, aluminum, or other materials.

In some instances, the one or more defects 120 may cause the one or more top electrodes 112 to undesirably contact (“shunt”) the semiconductor layer 110b. This undesirable contact between the one or more top electrodes 112 and the semiconductor layer 110b may reduce the efficiency of the semiconductor device 100 or could make the semiconductor device 100 inoperable. For example, if the semiconductor device 100 is a dual junction solar cell having indium gallium phosphide as the material for the semiconductor layer 110a and gallium arsenide as the material for the semiconductor layer 110b, the shunt may reduce the absorption efficiency of the dual junction solar cell because light absorbed in the semiconductor layer 110a may not be efficiently converted into electrical current. In another non-limiting example, if the semiconductor device 100 is a single junction solar cell with a single semiconductor layer (e.g., the semiconductor layer 110a), the one or more defects 120 may cause some of the one or more top electrodes 112 to undesirably contact the dielectric layer 106 and/or some of the one or more bottom electrodes 104, creating an unintentional “short.”

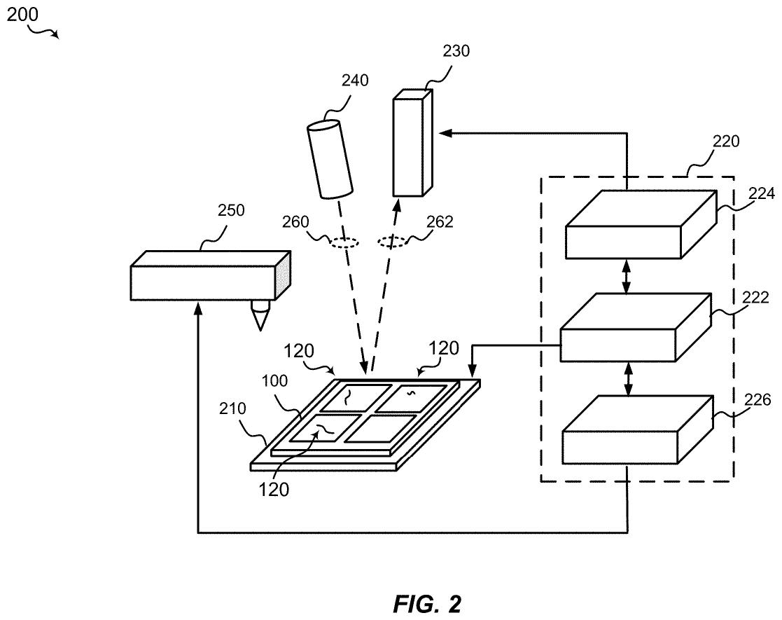

Referring now to FIG. 2, in some implementations, a defect reduction system 200 may include a stage 210, a control system 220, a detector 230, one or more light sources 240 and a deposition system 250. The stage 210, on which the semiconductor device 100 may be placed for processing, may include linear actuators and rotational actuators (e.g., servomotor) to control the vertical and horizontal translations and angular rotation of the stage 210. The stage 210 may heat and/or cool the semiconductor device 100 using heating coils and/or lower temperature gas such as liquid nitrogen or liquid helium. The control system 220 may include a stage controller 222 for transmitting signals, commands, and/or instructions to the stage 210 to control the translations and rotation of the stage 210. The control system 220 may include an optical controller 224 to control the detector 230 and/or the one or more light sources 240. The control system 220 may include a deposition controller 226 that transmits signals, commands, and/or instructions to the deposition system 250 to control the materials to deposit and/or the amount to deposit. The optical controller 224 may transmit signals, commands, and/or instructions to alter the output intensity of the one or more light sources 240, the incident angle of the light 260 (by changing the tilt of the one or more light sources 240, for example) and vertical and horizontal translations and angular rotation of the one or more light sources 240. The detector 230 may detect the one or more defects 120. The optical controller 224 may identify the one or more defects 120. The optical controller 224 may control the focus, sensitivity, field (dark or bright), or detection parameters of the detector 230. The optical controller 224 may detect patterns on the surface of the semiconductor device 100 based on reflection information received by the detector 230 from the surface of the semiconductor device 100. The optical controller 224 may include image processing capabilities to identify a fissure, a crack, a hole, an opening, a gap, a slit, a groove, a break, a fracture, a split, a fault, or other shapes associated with the one or more defects 120. The optical controller 224 may include image processing capabilities to identify the plurality of bottom electrodes 104, the dielectric layer 106, and the plurality of vias 108. The optical controller 224 may be able to process both bright-field and dark-field images.

Still referring to FIG. 2, during normal operations, the one or more light sources 240 of the defect reduction system 200 may emit the light 260 toward the semiconductor device 100. The light 260 may be a sub-bandgap light. For example, the wavelength of the light 260 may be 600 nanometers (nm), 700 nm, 800 nm, 900 nm, 1 micrometer (μm), 2 μm, 5 μm, 10 μm, 20 μm, 50 μm, 100 μm, 200 μm, 500 μm, or 1 millimeter (mm). Other wavelengths are possible. The light 260 may reflect off the carrier 102, the one or more bottom electrodes 104, the dielectric layer 106, the one or more vias 108, or a combination thereof. The reflected light 260 may become the reflected light 262. The reflected light 262 may include the photoluminescence light radiated from portions of the semiconductor device 100 when the light 260 impinges on the portions of the semiconductor device 100. The reflected light 262 may be detected by the detector 230.

In certain aspects, the detector 230 may receive the reflected light 262 to detect the one or more defects 120 on the semiconductor device 100. The reflected light 262 may include light reflected from one or more surfaces of the semiconductor device 100. For example, the reflected light 262 may include at least one of light reflected from the surfaces of the one or more top electrodes 112, the semiconductor layers 110a, 110b, the dielectric layer 106, the one or more bottom electrodes 104, and/or the optional carrier 102. The detector 230 may detect light having a wavelength of 300 nm, 400 nm, 500 nm 600 nm, 700 nm, 800 nm, 900 nm, 1 μm, 2 μm, 5 μm, 10 μm, 20 μm, 50 μm, 100 μm, 200 μm, 500 μm, or 1 mm. In one non-limiting example, the detector 230 may detect the one or more defects 120 by detecting the photoluminescence of the semiconductor layers 110a, 110b. Specifically, the detector 230 may detect the one or more defects 120 by detecting a difference (e.g., color, intensity, etc.) and/or a contrast in photoluminescence of the semiconductor layers 110a, 110b. The optical controller 220 may utilize the detected differences (e.g., color, intensity, etc.) to identify the one or more defects 120.

In some implementations, the optical controller 220 may track the locations of the one or more defects 120 in the semiconductor device 100. The optical controller 220 may maintain statistical information about the one or more defects 120. The optical controller 220 may reduce scanning to those areas where defects tend to occur more often than other areas.

In some implementations, the deposition system 250 may be configured to deposit metal, insulators, semiconductors, or other materials. The deposition system 250 may be an inkjet system, screen-printing system, 2D printing system, or other deposition systems, for example. In one example, the deposition system 250 may be an inkjet system configured to selectively deposit photo-resist onto the surface of the semiconductor device 100. In another example, the deposition system 250 may be configured to deposit a conductive material for the one or more top electrodes 112, such as elemental metal (e.g., electro-plated copper, inkjet-printed copper or copper precursor, screen printed copper, etc.) or alloys (e.g., indium tin oxide).

In other implementations, the defect reduction system 200, with or without the deposition system 250, may optionally be integrated with another deposition system (e.g., electro-plating system, a sputter, an evaporator, etc.), a cutting system (e.g., dicing, laser cutting, waterj et cutting, etc.), an etching system (e.g., dry etching, wet etching), and/or a probing system.

In one implementation, the optical controller 224 and the detector 230 may be configured to capture optical and/or photoluminescence images of the semiconductor device 100 to detect the one or more defects 120. Based on the captured optical and/or photoluminescence images and/or the locations information of the one or more defects 120, the optical controller 224 (including image processing hardware and/or software) may generate a mask pattern for the deposition of the one or more top electrodes that prevents shunting (as described above). Specifically, after the deposition of the one or more top electrodes 112, the one or more defects 120 may not be a shunting path between the one or more top electrodes 112 and the one or more bottom electrodes 104. In one non-limiting example, the deposition system 250 may deposit a correction mask onto the semiconductor device 100. The correction mask may prevent the one or more top electrodes 112 from contacting the semiconductor layer 110b according to aspects of the present disclosure described below.

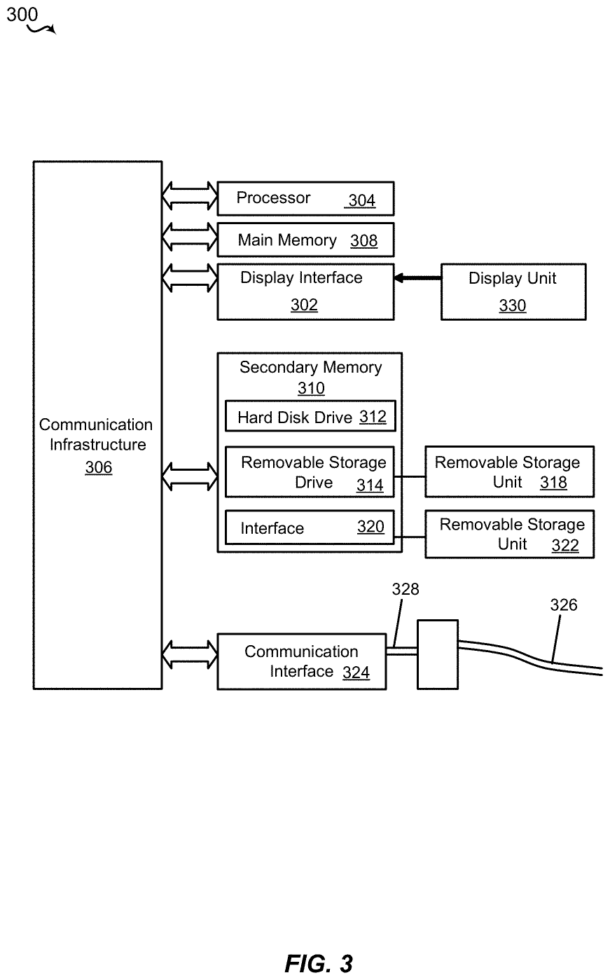

Referring now to FIG. 3, the control system 220 may be implemented as an example of a computer system 300. The computer system 300 may be a hardware system, a virtual system, a cloud-based system, or a combination thereof. The computer system 300 includes one or more processors, such as the processor 304. The processor 304 is communicatively coupled with a communication infrastructure 306 (e.g., a communications bus, cross-over bar, or network).

The computer system 300 may include a display interface 302 that forwards graphics, text, and other data from the communication infrastructure 306 (or from a frame buffer not shown) for display on a display unit 330. Computer system 300 also includes a main memory 308, preferably random access memory (RAM), and may also include a secondary memory 310. The secondary memory 310 may include, for example, a hard disk drive 312, and/or a removable storage drive 314, representing a floppy disk drive, magnetic tape drive, optical disk drive, universal serial bus (USB) flash drive, etc. The removable storage drive 314 reads from and/or writes to a first removable storage unit 318 in a well-known manner. The first removable storage unit 318 represents a floppy disk, magnetic tape, optical disk, USB flash drive etc., which is read by and written to removable storage drive 314. As will be appreciated, the first removable storage unit 318 includes a computer usable storage medium having stored therein computer software and/or data.

Alternative aspects of the present disclosure may include secondary memory 310 and may include other similar devices for allowing computer programs or other instructions to be loaded into computer system 300. Such devices may include, for example, a second removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units (not shown) and interfaces 320, which allow software and data to be transferred from the second removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328, which may be electronic, electromagnetic, optical or other signals capable of being received by communications interface 324. These signals 328 are provided to communications interface 324 via a communications path (e.g., channel) 326. This path 326 carries signals 328 and may be implemented using one or more of a wire or cable, fiber optics, telephone line, cellular link, RF link and/or other communications channels. In this document, the terms “computer program medium” and “computer usable medium” are used to refer generally to media such as the first removable storage drive 318, a hard disk installed in hard disk drive 312, and signals 328. These computer program products provide software to the computer system 300. Aspects of the present disclosure are directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features in accordance with aspects of the present disclosure, as discussed herein. In particular, the computer programs, when executed, enable the processor 304 to perform the features in accordance with aspects of the present disclosure. Accordingly, such computer programs represent controllers of the computer system 300.

In an aspect of the present disclosure where the method is implemented using software, the software may be stored in a computer program product and loaded into computer system 300 using removable storage drive 314, hard drive 312, or communications interface 320. The control logic (software), when executed by the processor 304, causes the processor 304 to perform the functions described herein. In another aspect of the present disclosure, the system is implemented primarily in hardware using, for example, hardware components, such as application specific integrated circuits (ASICs). Implementation of the hardware state machine so as to perform the functions described herein will be apparent to persons skilled in the relevant art(s).

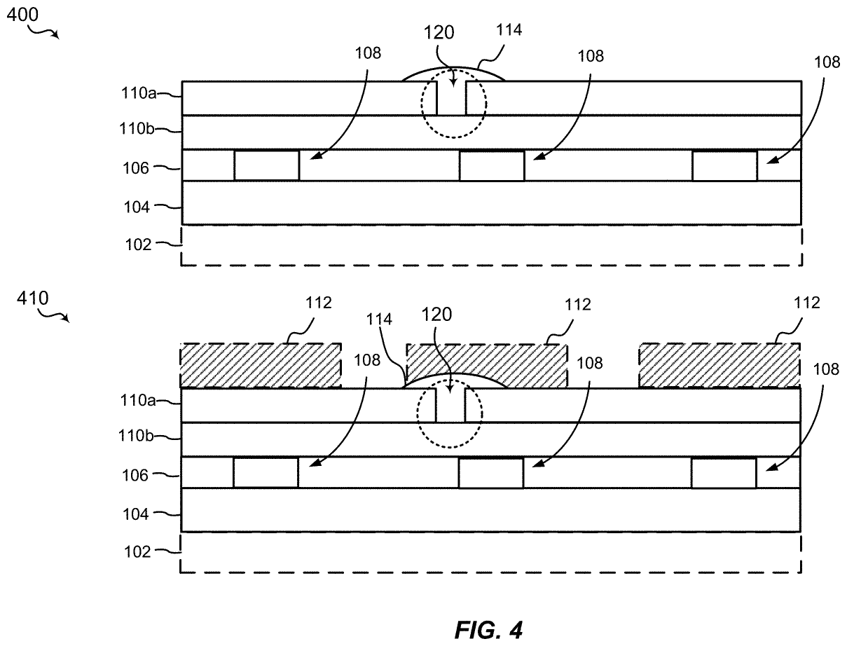

Referring now to FIG. 4, in some instances of the present disclosure, the defect reduction system 200 may reduce or eliminate the one or more defects 120 by filling the one or more defects 120 with an insulating material 114, such as a resin or a photo-resist, to avoid shunting. An example of a diagram 400 shows the deposition of the insulating material 114 in the one or more defects 120. An example of a diagram 410 shows the deposition of the one or more top electrodes 112 after the insulating material 114 is deposited into the one or more defects 120. For example, during operation, the one or more light sources 240 may transmit light toward the semiconductor device 100. The reflected light 262, caused by the photoluminescence from the semiconductor layers 110a, 110b, may be detected by the detector 230. For example, the reflected light 262 may include lights reflected from one or more surfaces of the semiconductor layers 110a, 110b. Based on the reflected light 262 detected by the detector 230, the optical controller 224 (including associated hardware and software for image processing) may identify and/or locate the one or more defects 120. Next, the deposition controller 226 may transmit signals to the deposition system 250 to cause the deposition system 250 to deposit the insulating material 114 into at least the one or more defects 120 (i.e., the correction mask). After an optional annealing, one or more metals (e.g., elemental or alloy) may be patterned, deposited, and/or etched to form the one or more top electrodes 112. Since the insulating material 114 remains in the one or more defects 120, the insulating material 114 prevents the one or more top electrodes 112 from contacting the semiconductor layer 110b. In one implementation, a layer of copper may be deposited as the material for the one or more top electrodes 112. This layer is deposited after the insulating material 114 has been deposited to prevent the defects 120 to produce shunts. The patterning and/or etch of the copper may be performed using screen printing, inkjet printing, liftoff, and/or an etch mask and dry and/or wet etching. In an implementation, the copper may be electro-plated copper.

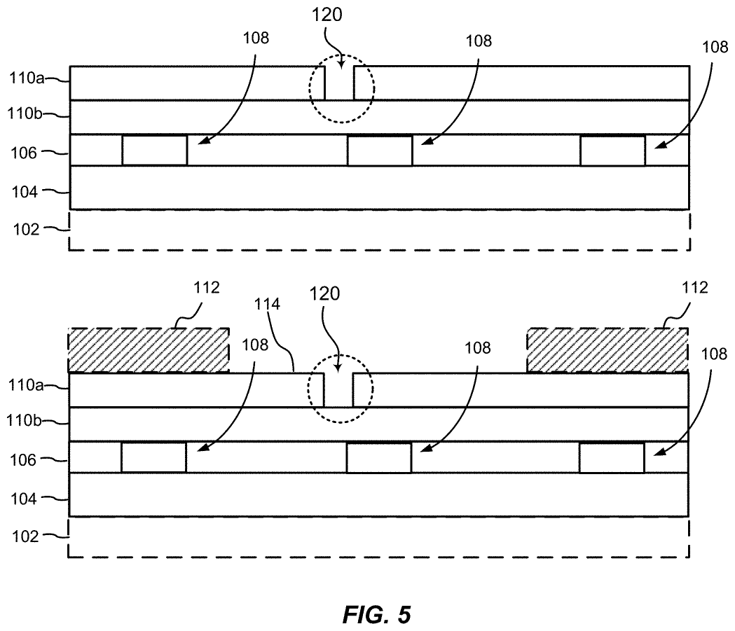

Referring now to FIG. 5, in another implementation of the present disclosure, the defect reduction system 200 may reduce or eliminate the negative effects (e.g., shunt) of the one or more defects 120 by selectively preventing the deposition of at least one of the one or more top electrodes 112 to avoid shunting. For example, during operation, the one or more light sources 240 may transmit light toward the semiconductor device 100. The reflected light 262, caused by the photoluminescence from the semiconductor layers 110a, 110b, may be detected by the detector 230. For example, the reflected light 262 may include lights reflected from one or more surfaces of the semiconductor layers 110a, 110b. Based on the reflected light 262 detected by the detector 230, the optical controller 224 (including associated hardware and software for image processing) may identify and/or locate the one or more defects 120. Next, the deposition controller 226 may transmit signals to the deposition system 250 to cause the deposition system 250 to avoid depositing the at least one of the one or more top electrodes 112. The at least one of the one or more top electrodes 112 may be a top electrode that would have been deposited over the one or more defects 120. By not depositing the at least one of the one or more top electrodes 112, the defect reduction system 200 may prevent shunting of the semiconductor layer 110a. By not depositing the at least one of the one or more top electrodes, the electrical characteristics of the semiconductor 100 may not be significantly affected. In one instance, the deposition controller 226 may transmit signals to the deposition system 250 to cause the deposition system 250 to not deposit the at least one of the one or more top electrodes 112 that would have been deposited over the one or more defects 120. In another instances, the deposition controller 226 may transmit signals to the deposition system 250 to cause the deposition system 250 to deposit a masking material (not shown) into the at least one of the one or more defects 120 and/or covering an area around the at least one of the one or more defects 120. After the deposition of the conducting material for the one or more top electrodes 112 (e.g., electro-plated copper), a liftoff process may be performed to prevent metal deposition near the one or more defects 120.

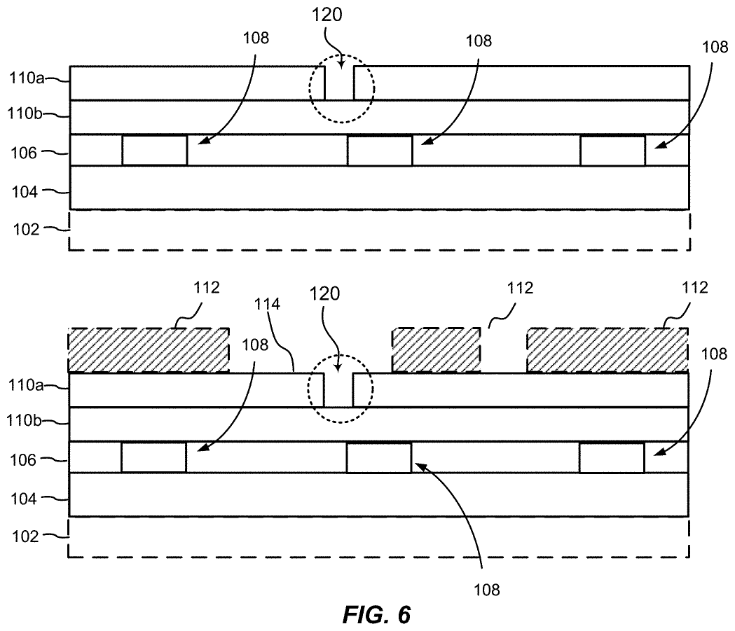

Referring now to FIG. 6, in another implementation of the present disclosure, the defect reduction system 200 may reduce or eliminate the negative effects (e.g., shunt) of the one or more defects 120 by changing the position and/or size of at least one of the one or more top electrodes 112 to avoid an overlap between the at least one of the one or more top electrodes 112 and the one or more defects 120. For example, during operation, the one or more light sources 240 may transmit light toward the semiconductor device 100. The reflected light 262, caused by the photoluminescence from the semiconductor layers 110a, 110b, may be detected by the detector 230. For example, the reflected light 262 may include lights reflected from one or more surfaces of the semiconductor layers 110a, 110b. Based on the reflected light 262 detected by the detector 230, the optical controller 224 (including associated hardware and software for image processing) may identify and/or locate the one or more defects 120. Next, the deposition controller 226 may transmit signals to the deposition system 250 to cause the deposition system 250 to change the position and/or size the at least one of the one or more top electrodes 112. The at least one of the one or more top electrodes 112 may be a top electrode that would have been deposited over the one or more defects 120. By changing the position and/or size of the at least one of the one or more top electrodes 112, the defect reduction system 200 may prevent shunting of the semiconductor layer 110a. In one instance, the deposition controller 226 may transmit signals to the deposition system 250 to cause the deposition system 250 (e.g., an inkjet system capable of printing conductive materials) to shift the at least one of the one or more top electrodes 112 to avoid been deposited over the one or more defects 120. In another example, the deposition controller 226 may transmit signals to the deposition system 250 to cause the deposition system 250 to reduce the size of the at least one of the one or more top electrodes 112 to avoid been deposited over the one or more defects 120. In some circumstances, the deposition controller 226 may transmit signals to the deposition system 250 to cause the deposition system 250 to shift and reduce the size of the at least one of the one or more top electrodes 112 (as shown in FIG. 6).

In some implementations, the control system 220 and/or the deposition controller 226 may include hardware and/or software algorithm to determine which method(s) of defect reduction or defect compensation to use. For example, the control system 220 and/or the deposition controller 226 may rely on the minimum feature size of the semiconductor device 100, locations and/or sizes of the one or more defects 120, planarization requirement, thermal budget, yield, complexity of manufacturing, and/or other factors, to determine the method(s) of defect reduction. In one instance, the control system 220 and/or the deposition controller 226 may determine to fill the one or more defects 120 due to the requirement of maximizing a number of the one or more top electrodes 112 (and, consequently, active solar cells). In another instance, the control system 220 and/or the deposition controller 226 may determine to prevent the deposition of the at least one of the one or more top electrodes 112 to simply the manufacturing process. In yet another instance, the control system 220 and/or the deposition controller 226 may determine to shift or resize the at least one of the one or more top electrodes 112 because the one or more defects 120 is small (e.g., <100 nm long) and is situated near an edge of the one or more top electrodes 112 (i.e., only minimum shifting/resizing is required to prevent shunt).

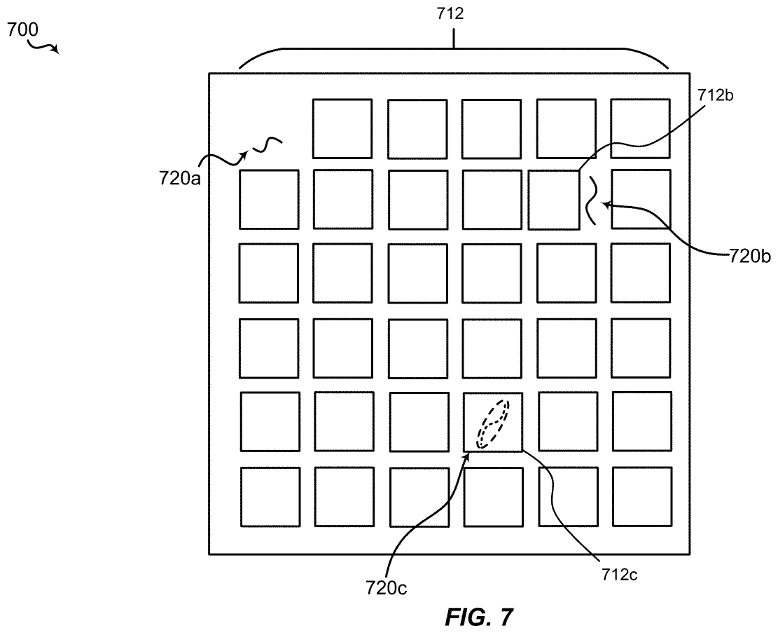

Referring to FIG. 7, an example of defect reduction may include a semiconductor device 700 having one or more top electrodes 712, a first defect 720a, a second defect 720b, and a third defect 720c. For the first defect 720a, the defect reduction system 200 may prevent a first electrode (not shown) of the one or more top electrodes 712 from being deposited onto the semiconductor device 700. For the second defect 720b, the defect reduction system 200 may shift and resize a second electrode 712b of the one or more top electrodes 712 to avoid deposition over the second defect 720b. For the third defect 720c, the defect reduction system 200 may fill the third defect 720c before depositing a third top electrode 712c of the one or more top electrodes 712 to prevent shunting.

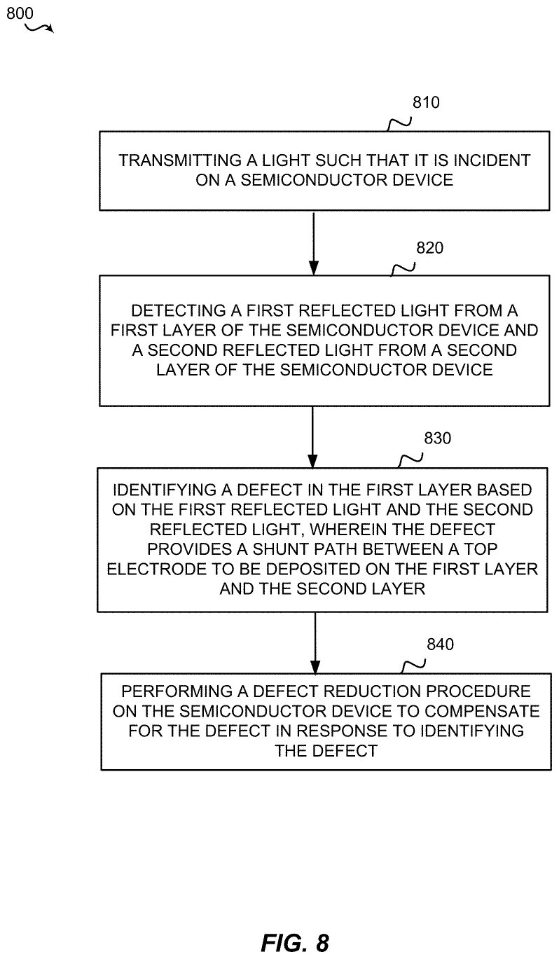

Referring to FIG. 8, an example of a method 800 for reducing defects may be performed by the control system 220, the optical controller 224, or associated hardware and/or software of the defect reduction system 200.

At block 810, the method 800 may transmit a light such that it is incident on a semiconductor device. For example, the optical controller 224 may cause the one or more light sources 240 to transmit the light 260 toward the semiconductor layers 110a, 110b of the semiconductor device 100.

At block 820, the method 800 may detect a first reflected light from a first layer of the semiconductor device and a second reflected light from a second layer of the semiconductor device. For example, the detector 330 may detect the reflected light 262 including a first reflected light from the semiconductor 110a and a second reflected light from the semiconductor 110b. In one instance, the first reflected light and the second reflected light may be caused by the photoluminescence response after the light 260 from the one or more light sources 240 impinging on the semiconductor layer 110a and the semiconductor layer 110b, respectively. In another example, the first reflected light and the second reflected light may be the reflect visible light after the light 260 from the one or more light sources 240 impinging on the semiconductor layer 110a and the semiconductor layer 110b, respectively.

At block 830, the method 800 may identify a defect in the first layer based on the first reflected light and the second reflected light, wherein the defect is a defect provides a shunt path between a top electrode to be deposited on the first layer and the second semiconductor layer. For example, the optical controller 224 may identify the one or more defects 120 based on detecting a difference (e.g., color, intensity, etc.) and/or a contrast in photoluminescence of the semiconductor layers 110a, 110b.

At block 840, the method 800 may perform a defect reduction procedure on the semiconductor device to compensate for the defect in response to identifying the defect. For example, the defect reduction system 200 may reduce or eliminate the one or more defects 120 by filling the one or more defects 120 with the insulating material 114, such as photo-resist, to avoid shunting. Alternatively, the defect reduction system 200 may reduce or eliminate the one or more defects 120 by selectively preventing the deposition of at least one of the one or more top electrodes 112 to avoid shunting. In another implementation, the defect reduction system 200 may reduce or eliminate the one or more defects 120 by changing the position and/or size of at least one of the one or more top electrodes 112 to avoid shunting.

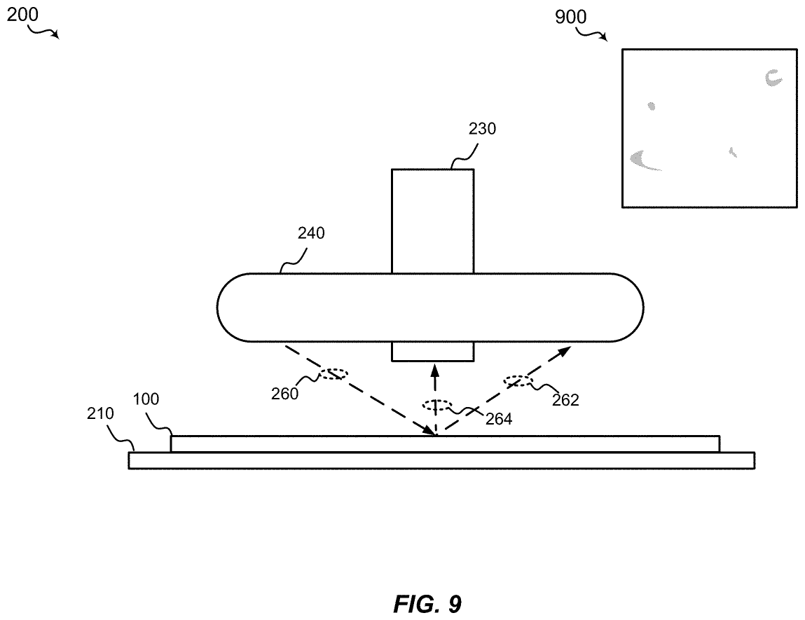

Turning now to FIG. 9, in another implementation of the defect reduction system 200, the semiconductor device 100 may be placed on the stage 210 of the defect reduction system 200. The one or more light sources 240 of the defect reduction system 200 may emit the light 260 toward the semiconductor device 100. The light 260 may reflect off the carrier 102, the one or more bottom electrodes 104, the dielectric layer 106, the one or more vias 108, or a combination thereof. The light 260 reflected off the carrier 102, the one or more bottom electrodes 104, the dielectric layer 106, the one or more vias 108, or a combination thereof may become the reflected light 262. The reflected light 262 may not be detected by the detector 230. In a non-limiting example, the one or more light sources 240 may be placed such that the reflected light 262 does not travel toward the detector 230.

In some implementations, when the light 260 impinges on a portion of the one or more defects 120 (e.g., the side wall), a scattered light 264 may be scattered from the portion of the one or more defects 120. In certain aspects, the detector 230 may receive the scattered light 264 to detect the one or more defects 120 on the semiconductor device 100. The scattered light 264 may include light scattered from the portion of the one or more defects 120. Based on the scattered light 264 received by the detector 230, the optical controller 224 may generate a captured image 900.

In a non-limiting example of the present disclosure, the optical controller 224 may capture a number of images to generate the captured image 900 of the semiconductor device 100. The optical controller 224 may cause the one or more light sources 240 and/or the detector 230 to “raster scan” across the semiconductor device 100. The optical controller 224 may “stich” the number of images together to generate the captured image 900. The number of images may overlap (e.g., 0.5 millimeter (mm), 1 mm, 2 mm, 3 mm, 5 mm, or other overlap dimensions) or not overlap. In some instances, the number of images may be 4 images, 25 images, 100 images, 2000 images, or other numbers. The number may be determined based on resolutions of the detector 230, average sizes of the one or more defects 120, maximum time spent generating the captured image 900, or other criteria.

In some aspects of the present disclosure, the one or more light sources 240 in the defect reduction system 200 shown in FIG. 9 may be a “ring” of lights surrounding detector 230. The one or more light sources 240 may be configured to emit collimated light. The one or more light sources 240 may emit monochromatic or broadband lights.

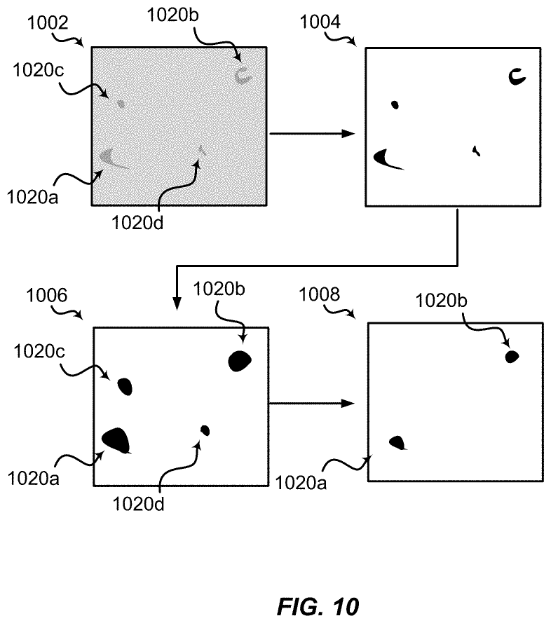

Turning now to FIG. 10, in some implementations, the optical controller 224 may perform image processing techniques on the images captured by the detector 230 (e.g., the captured image 900) to generate processed images 1002, 1004, 1006, 1008. For example, the optical controller 224 may isolate a channel of the captured image to generate the processed image 1002. Examples of a channel include a red channel, a green channel, a blue channel, a hue channel, a saturation channel, and a value channel. In some instances, the optical controller 224 may isolate the value channel of the captured image to generate the processed image 1002. The processed image 1002 may show defects 1020a-d. The value channel may include the luminance intensity of pixels of the captured image.

Next, the optical controller 224 may select a threshold intensity value to convert the processed image 1002 into the processed image 1004 by filtering the processed image 1002 using the threshold intensity value. Pixels having intensity values above the threshold intensity value may have the intensity values rounded up to a predetermined ceiling value (e.g., full intensity). Pixels having intensity values below the threshold intensity value may have the intensity values rounded down to a predetermined floor value (e.g., 0 intensity). The processed image 1004 may have a sharper contrast than the processed image 1002. For example, a contract between one of the defects 1020a-d and the background of the processed image 1004 may be increased.

Next, the optical controller 224 may perform a dilation process on the processed image 1004 to generate the processed image 1006. During the dilation process, any pixel having one or more neighboring pixels with a value above a predetermined dilation threshold may have its pixel intensity value set to a predetermined dilation ceiling value. As a result of the dilation process, as shown in the processed image 1006, the defects 1020a-d may increase in sizes.

Next, the optical controller 224 may perform an erosion process on the processed image 1006 to generate the processed image 1008. During the erosion process, any pixel, when aligned to a predetermined structuring element, having neighboring pixels (and/or itself) not achieving certain predetermined criteria (e.g., the structuring element not fully contained) may have its pixel intensity value set to a predetermined erosion floor value. As a result of the erosion process, as shown in the processed image 1008, the defects 1020a-d may decrease in sizes, possible disappearing as shown for the defects 1020c, 1020d. The dilation and erosion process may eliminate certain smaller artifacts that appear as defects.

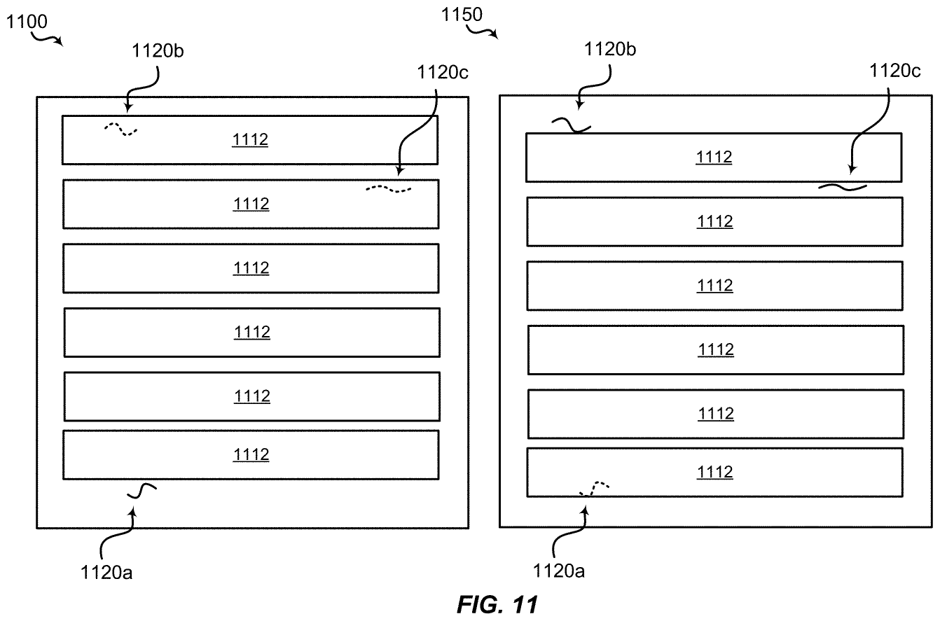

Turning now to FIG. 11, a first example of an offset defect reduction technique is shown. In some implementations, the defect reduction system 200 may use the images, such as the captured image 900 or the processed image 1008, to reduce defects. In some aspects, an example of the offset defect reduction may include a semiconductor device 1100 having one or more top electrodes 1112, a first defect 1120a, a second defect 1120b, and a third defect 1120c. The first defect 1120a, second defect 1120b, and third defect 1120c may be unwanted materials deposited on a layer beneath the one or more top electrodes 1112 (e.g., on a semiconductor layer) or undesirable structure associated with the layer beneath the one or more top electrodes 1112 (e.g., delaminated semiconductor layer). The semiconductor device 1100 as shown has not undergone any defect reduction process described in the current application. By performing the offset defect reduction technique on a semiconductor 1150, the one or more top electrodes 1112 may be shifted (e.g., by shifting the mask used during the deposition of the one or more top electrodes 1112) to avoid overlapping with the first defect 1120a and the second defect 1120b. Even though the shift may cause the one or more top electrodes 1112 to avoid overlapping with the first defect 1120a and the second defect 1120b, it may be possible that the shift may overlap with the third defect 1120c. In some non-limiting implementations, the offset defect reduction technique may minimize the overlap (e.g., number of defects overlapping with electrodes, area of overlap between the defects and the electrodes, etc.) between the one or more top electrodes 1112 and the defects 1120a, 1120b, 1120c. By shifting the one or more top electrodes 1112 as shown in FIG. 11, the number of overlap between the one or more top electrodes 1112 and the defects 1120a, 1120b, 1120c decreases (even though the first defect 1120a overlaps with the one or more top electrodes 1112).

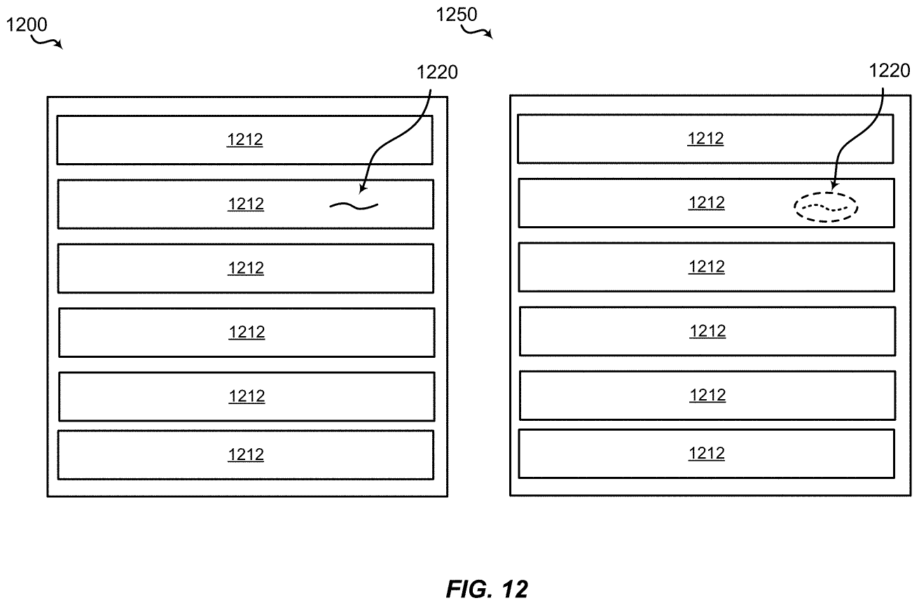

Turning now to FIG. 12, a first example of a backfill defect reduction technique is shown. In some implementations, the defect reduction system 200 may use the images, such as the captured image 900 or the processed image 1008, to reduce defects. In some aspects, an example of the backfill defect reduction may include a semiconductor device 1200 having one or more top electrodes 1212 and a defect 1220. The defect 1220 may be unwanted materials deposited on a layer beneath the one or more top electrodes 1212 (e.g., on a semiconductor layer) or undesirable structure associated with the layer beneath the one or more top electrodes 1212 (e.g., delaminated semiconductor layer). The semiconductor device 1200 as shown has not undergone any defect reduction process described in the current application. By performing the backfill defect reduction technique on a semiconductor 1250, the defect reduction system 200 may cover the defect 1220 before depositing the one or more top electrodes 1212 to prevent shunting.

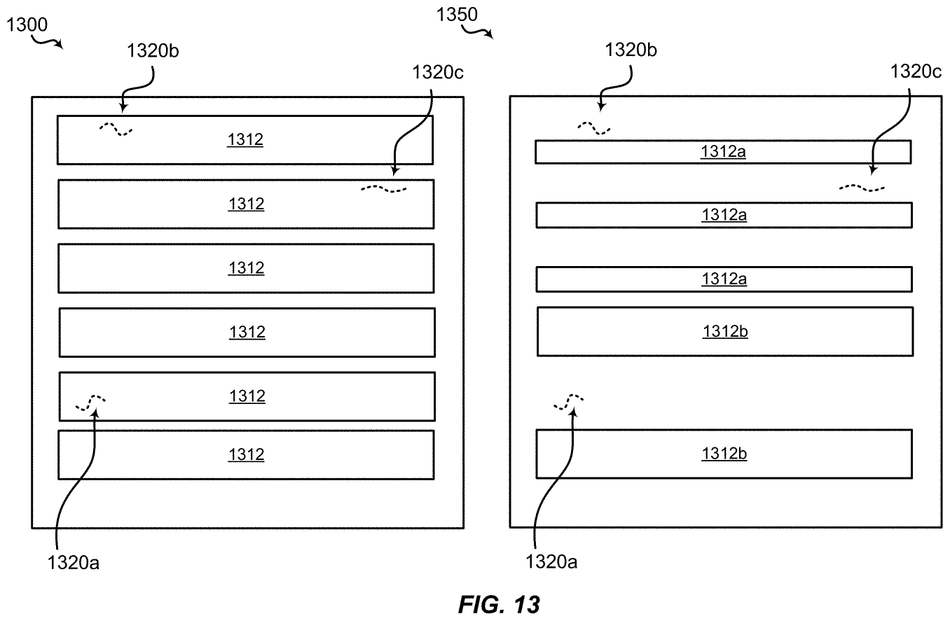

Turning now to FIG. 13, a first example of a mask-modification defect reduction technique is shown. In some implementations, the defect reduction system 200 may use the images, such as the captured image 900 or the processed image 1008, to reduce defects. In some aspects, an example of the mask-modification defect reduction may include a semiconductor device 1300 having one or more top electrodes 1312, a first defect 1320a, a second defect 1320b, and a third defect 1320c. The first defect 1320a, second defect 1320b, and third defect 1320c may be unwanted materials deposited on a layer beneath the one or more top electrodes 1312 (e.g., on a semiconductor layer) or undesirable structure associated with the layer beneath the one or more top electrodes 1312 (e.g., delaminated semiconductor layer). The semiconductor device 1300 as shown has not undergone any defect reduction process described in the current application. By performing the offset defect reduction technique on a semiconductor 1350, the shapes, widths, lengths, pitch, spacing, or other factors associated with the one or more top electrodes 1312 may be altered (by altering the mask used during the deposition of the one or more top electrodes 1312) to avoid overlapping with the first defect 1320a, the second defect 1320b, and the third defect 1320c. For example, the widths of the one or more top electrodes 1312a may be reduced to avoid overlapping with the second defect 1320b and the third defect 1320d. In another example, the pitch (e.g., distance between the electrodes) of the one or more top electrodes 1312b may be increased (thus reducing the number of electrodes in a unit length or area) to avoid overlapping with the first defect 1320a. In a non-limiting examples, some of the one or more top electrodes 1312 may be selectively removed. Other methods of mask modifications may also be implemented to reduce the impact of the defects.

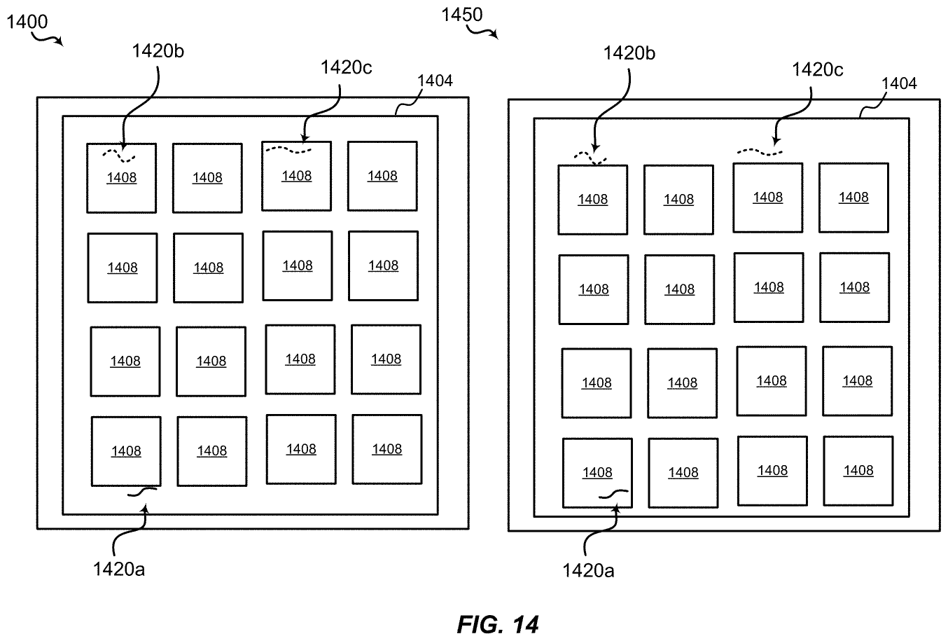

Turning now to FIG. 14, a second example of an offset defect reduction technique is shown. In some implementations, the defect reduction system 200 may use the images, such as the captured image 900 or the processed image 1008, to reduce defects. In some aspects, an example of the offset defect reduction may include a semiconductor device 1400 having one or more bottom electrodes 1404, one or more vias 1408, a first defect 1420a, a second defect 1420b, and a third defect 1420c. The first defect 1420a, second defect 1420b, and third defect 1420c may be unwanted materials deposited on the one or more bottom electrodes 1404 or undesirable structure associated with the one or more bottom electrodes 1404 (e.g., delamination, peeling, over-etching, etc.). The semiconductor device 1400 as shown has not undergone any defect reduction process described in the current application. By performing the offset defect reduction technique on a semiconductor 1450, the one or more vias 1408 may be shifted (e.g., by shifting the mask used during the etching of the one or more vias 1408) to avoid overlapping of the first defect 1420a and the second defect 1420b with the one or more vias 1408. Even though the shift may cause the one or more vias 1408 to avoid overlapping with the first defect 1420a and the second defect 1420b, it may be possible that the shift may cause the one or more vias 1408 to overlap with the third defect 1420c. In some non-limiting implementations, the offset defect reduction technique may minimize the overlap (e.g., number of defects overlapping with electrodes, area of overlap between the defects and the electrodes, etc.) between the one or more vias 1408 and the defects 1420a, 1420b, 1420c. By shifting the one or more vias 1408 as shown in FIG. 14, the number of overlap between the one or more vias 1408 and the defects 1420a, 1420b, 1420c decreases (even though the first defect 1420a overlaps with the one or more top electrodes (not shown)).

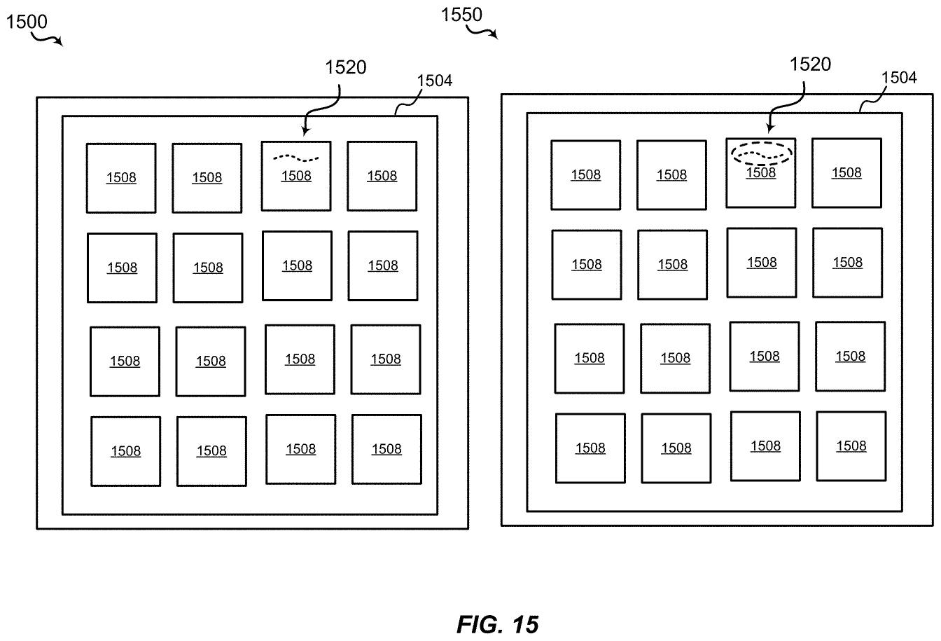

Turning now to FIG. 15, a second example of a backfill defect reduction technique is shown. In some implementations, the defect reduction system 200 may use the images, such as the captured image 900 or the processed image 1008, to reduce defects. In some aspects, an example of the backfill defect reduction may include a semiconductor device 1500 having one or more bottom electrodes 1504, one or more vias 1508, and a defect 1520. The defect 1520 may be unwanted materials deposited on the one or more bottom electrodes 1504 or undesirable structure associated with the one or more bottom electrodes 1504 (e.g., delamination, peeling, over-etching, etc.). The semiconductor device 1500 as shown has not undergone any defect reduction process described in the current application. By performing the backfill defect reduction technique on a semiconductor 1550, the defect reduction system 200 may cover the defect 1520 before depositing a subsequent layer (e.g., the semiconductor layer) over the one or more vias 1508.

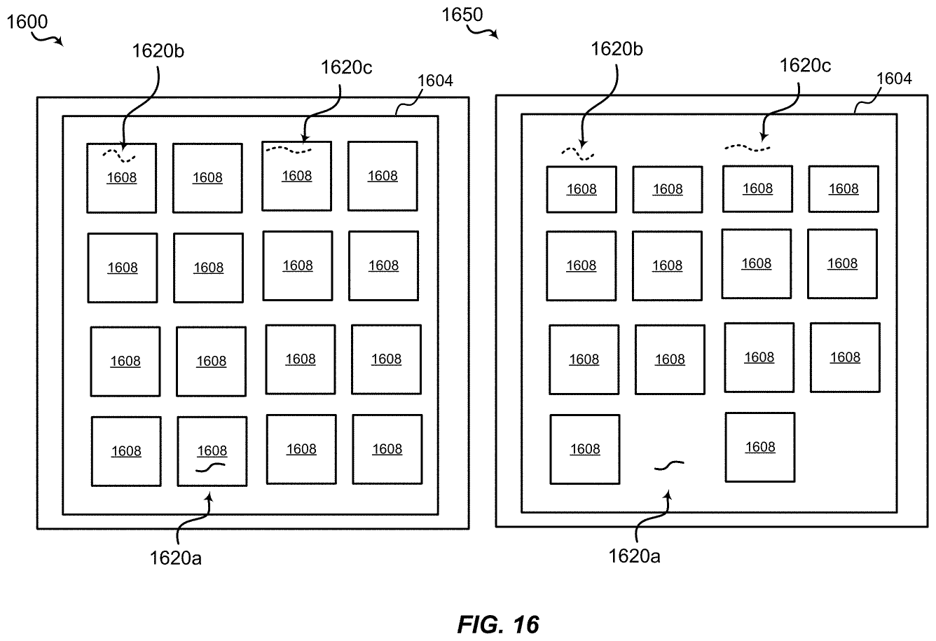

Turning now to FIG. 16, a second example of a mask-modification defect reduction technique is shown. In some implementations, the defect reduction system 200 may use the images, such as the captured image 900 or the processed image 1008, to reduce defects. In some aspects, an example of the mask-modification defect reduction may include a semiconductor device 1600 having one or more bottom electrodes 1604, one or more vias 1608, a first defect 1620a, a second defect 1620b, and a third defect 1620c. The semiconductor device 1600 as shown has not undergone any defect reduction process described in the current application. By performing the offset defect reduction technique on a semiconductor 1650, the shapes, widths, lengths, pitch, spacing, or other factors associated with the one or more vias 1608 may be altered (by altering the mask used during the etching of the one or more vias 1608) to avoid overlapping with the first defect 1620a, the second defect 1620b, and the third defect 1620c. For example, the lengths of the one or more vias 1608 may be reduced to avoid overlapping with the first defect 1620a and the second defect 1620b. In another example, the pitch (e.g., distance between the vias) of the one or more vias 1608 may be increased (thus reducing the number of vias in a unit length or area) to avoid overlapping with the first defect 1620a. In a non-limiting examples, some of the one or more vias 1608 may be selectively removed. Other methods of mask modifications may also be implemented to reduce the impact of the defects.

In some instances, the offset defect reduction technique, the backfill defect reduction technique, and/or the mask-modification defect reduction technique may be implemented on other layers of semiconductor device 100, such as the one or more bottom electrodes 104 or the first semiconductor layer 110.

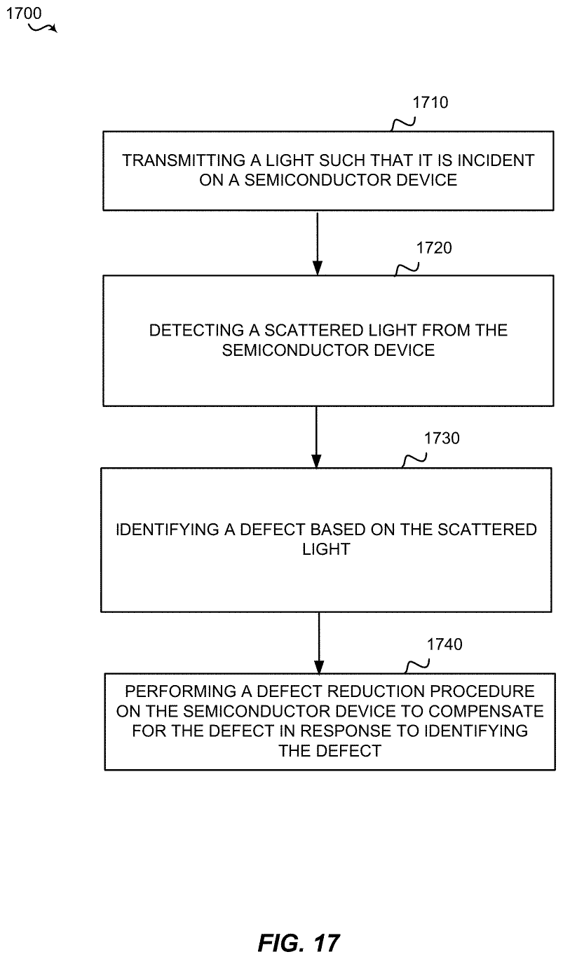

Referring to FIG. 17, an example of a method 1700 for reducing defects may be performed by the control system 220, the optical controller 224, or associated hardware and/or software of the defect reduction system 200.

At block 1710, the method 1700 may transmit a light such that it is incident on a semiconductor device. For example, the optical controller 224 may cause the one or more light sources 240 to transmit the light 260 toward the semiconductor layers 110a of the semiconductor device 100.

At block 1720, the method 1700 may detect a scattered light from the semiconductor device. For example, the detector 330 may detect light scattered from the sidewalls of the one or more defects 120.

At block 1730, the method 1700 may identify a defect based on the scattered light. For example, the optical controller 224 may identify the one or more defects 120 based on the scattered light from the one or more defects 120. In some implementations, the optical controller 224 may perform image process techniques described with respect to FIG. 10 to locate the one or more defects 120.

At block 1740, the method 1700 may perform a defect reduction procedure on the semiconductor device to compensate for the defect in response to identifying the defect. For example, the defect reduction system 200 may reduce or eliminate the negative impacts (e.g., shunt) of the one or more defects 120 by performing the defect reduction techniques described with respect to FIGS. 11-16.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

1. A method of reducing defects, comprising:
transmitting a light such that is incident on a semiconductor device;
detecting a first reflected light from a first layer of the semiconductor device and a second reflected light from a second layer of the semiconductor device;
identifying a defect in the first layer based on the first reflected light and the second reflected light, wherein the defect provides a shunt path between a top electrode to be deposited on the first layer and the second layer; and
performing a defect reduction procedure on the semiconductor device to compensate for the defect in response to identifying the defect.

2. The method of claim 1, wherein the defect reduction procedure comprises filling the defect with an insulating material.

3. The method of claim 2, wherein the insulating material includes a resin or a photo-resist.

4. The method of claim 1, wherein the defect reduction procedure comprises selectively preventing the deposition of the top electrode over the defect.

5. The method of claim 1, wherein the defect reduction procedure comprises changing a size or a position of the top electrode to be deposited onto the first layer to avoid an overlap between the top electrode and the defect.

6. (canceled)

7. The method of claim 6, wherein identifying the defect further comprises identifying a fissure, a crack, a hole, an opening, a gap, a slit, a groove, a break, a fracture, a split, or a fault in the first layer.

8. A defect reduction system, comprising:
a deposition system;
one or more light sources configured to transmit a light such that is incident on a semiconductor device;
a detector configured to detect a first reflected light from a first layer of the semiconductor device and a second reflected light from a second layer of the semiconductor device;
an optical controller configured to identify a defect in the first layer based on the first reflected light and the second reflected light, wherein the defect provides a shunt path between a top electrode to be deposited on the first layer and the second layer; and
a deposition controller configured to perform a defect reduction procedure on the semiconductor device to compensate for the defect in response to identifying the defect.

9. The defect reduction system of claim 8, wherein the deposition controller is configured to perform the defect reduction procedure by causing the deposition system to fill the defect with an insulating material.

10. The defect reduction system of claim 9, wherein the insulating material includes a resin or a photo-resist.

11. The defect reduction system of claim 8, wherein the deposition controller is configured to perform the defect reduction procedure by causing the deposition system to selectively prevent the deposition of the top electrode over the defect.

12. The defect reduction system of claim 8, wherein the deposition controller is configured to perform the defect reduction procedure by causing the deposition system to change a size or a position of the top electrode to be deposited onto the first layer to avoid an overlap between the top electrode and the defect.

13. (canceled)

14. The defect reduction system of claim 13, wherein identifying the defect further comprises identifying a fissure, a crack, a hole, an opening, a gap, a slit, a groove, a break, a fracture, a split, or a fault in the first layer.

15-20. (canceled)

21. A method of reducing defects, comprising:
transmitting a light such that it is incident on a semiconductor device;
detecting a scattered light from the semiconductor device;
identifying a defect based on the scattered light; and
performing a defect reduction procedure on the semiconductor device to compensate for the defect in response to identifying the defect.

22. The method of claim 21, wherein performing the defect reduction procedure comprises performing at least one of an offset defect reduction technique, a backfill defect reduction technique, or a mask-modification defect reduction technique.

23. The method of claim 22, wherein performing the defect reduction procedure comprises performing the offset defect reduction technique on one or more vias or one or more top electrodes.

24. The method of claim 22, wherein performing the defect reduction procedure comprises performing the backfill defect reduction technique on one or more vias or one or more top electrodes.

25. The method of claim 22, wherein performing the defect reduction procedure comprises performing the mask-modification defect reduction technique on one or more vias or one or more top electrodes.

26. The method of claim 21, wherein identifying the defect comprises:
capturing an image of the scattered light from the semiconductor device;
isolating a channel of the image to generate a channel image;
selecting a threshold intensity value;
filtering the channel image using the threshold intensity value to generate a filtered image;
performing a dilation on the filtered image to generate a dilated image;
performing an erosion on the dilated image to generate an eroded image; and
locating the defect shown in the eroded image.

27. The method of claim 21, wherein transmitting the light comprises transmitting the light via a ring of light.

28. The method of claim 21, wherein detecting the scattered light comprises detecting the scattered light without detecting a reflected light from the semiconductor device.
